(19) United States
(12) Patent Application Publication
(10) Pub. No.: US 2018/0172635 A1
(43) Pub. Date: Jun. 21, 2018

(54) METHODS AND DEVICES FOR MOISTURE-BASED CALIBRATION

(71) Applicant: Rapiscan Systems, Inc., Torrance, CA (US)

(72) Inventors: Hanh T. Lai, Arlington, MA (US); Wilhelm P. Platow, Newburyport, MA (US)

(21) Appl. No.: 15/379,834

(22) Filed: Dec. 15, 2016

(51) Int. Cl. G01N 27/62; H01J 49/00

(52) U.S. Cl. CPC G01N 27/622; H01J 49/0031; H01J 49/0009

(57) ABSTRACT

The present disclosure is directed to methods and devices for moisture-based calibration. In particular, the present disclosure is directed to moisture monitoring devices that trigger calibration of substance detection devices.

### BACKGROUND OF THE DISCLOSURE

The embodiments described herein relate generally to methods and devices for moisture-based calibration, such as, for example, ion mobility calibration. In particular, the present disclosure is directed to moisture monitoring devices that trigger calibration of substance detection devices. The substance detection devices are used, for example, to detect chemical substances, such as explosives, narcotics, pesticides, and chemical warfare agents.

In substance detection devices, moisture has a negative effect on identifying a substance of interest. For example, moisture can affect the drift time of an ion swarm within an ion mobility spectrometry (IMS) device. Depending on the analyte ion species, the degree of clustering with water molecules varies and increases at increasing moisture levels which causes undesirable peak shifts and detection algorithm problems. Therefore, IMS devices are typically equipped with a dryer system which scrubs the input air to low ppm of water content before it enters the detector.

The effectiveness of the dryer consistently supplying dried air to a desired ppm level is assumed to be constant over the life-time of the dryer as well as independent of humidity level of ambient air on a given day. However, without an actual moisture monitoring device to accurately report the moisture content and trigger for the system to be recalibrated, the shift in moisture level due to damaged or end-of-life dryer and/or change in ambient conditions can cause a significant mobility shift that results in missed alarms (false negatives) for substances of interest.

There remains a need, therefore, to address the moisture problem in substance detection devices by directly measuring the moisture content and then correcting for it with an improved detection algorithm.

### BRIEF DESCRIPTION OF THE DISCLOSURE

In one embodiment of the present disclosure, a substance detection device is disclosed. The device comprises an inlet for receiving a sample to be tested for the presence of at least one substance of interest; an ionization chamber; a drift chamber; and, at least one moisture sensor.

In another embodiment of the present disclosure, a method for calibrating a substance detection device is disclosed. The method comprises measuring a moisture content within a substance detection device; reporting the moisture content; and, performing a calibration, wherein the calibration adjusts at least one of a mobility value, a drift time value and a compensation voltage of at least one substance of interest.

In yet another embodiment of the present disclosure, a method for detecting a substance of interest is disclosed. The method comprises collecting a sample of a substance of interest; inserting the sample of the substance of interest into a substance detection device, wherein the device comprises an inlet for receiving a sample to be tested for the presence of at least one substance of interest; an ionization chamber; a drift chamber; and, at least one moisture sensor; measuring a moisture content within the device; reporting the moisture content; and, comparing at least one of a mobility value, a drift time value and a compensation voltage of the substance of interest to a pre-determined mobility value, drift time value or compensation voltage; and, identifying the substance of interest.

In another embodiment of the present disclosure, a method for servicing a substance detection device is disclosed. The method comprises measuring a moisture content within a substance detection device, wherein the device includes at least one moisture sensor; and, servicing the substance detection device.

In yet another embodiment of the present disclosure, a method for detecting a leak in a substance detection device is disclosed. The method comprises measuring a moisture content within a substance detection device, wherein the device includes at least one moisture sensor; and, identifying a leak within the substance detection device.

### BRIEF DESCRIPTION OF THE DRAWINGS

FIG. 1 is an exemplary embodiment of a substance detection device in accordance with the present disclosure.

FIG. 2 is an exemplary embodiment of a method for calibrating a substance detection device in accordance with the present disclosure.

FIG. 3 is an exemplary embodiment of a method for calibrating a substance detection device in accordance with the present disclosure.

FIG. 4 is an exemplary embodiment of a plot of peak positions for different substances of interest at various humidity levels in accordance with the present disclosure.

### DETAILED DESCRIPTION OF THE DISCLOSURE

The present disclosure is directed to methods and devices for moisture-based calibration, such as, for example, ion mobility calibration and compensation voltage-based calibration. In particular, the present disclosure is directed to moisture monitoring devices that trigger calibration of substance detection devices. The present disclosure is further directed to directly measuring the moisture content in a substance detection device and then correcting for it with an improved detection algorithm.

The disclosure described herein includes the use of moisture sensors to monitor, for example, the water vapor or humidity content of gas within a substance detection device flow circulation and triggers a smart calibration such as, for example, a mobility calibration or a compensative voltage-based calibration. As used herein, the term “moisture” includes water vapor, humidity, water, and any condensed or diffused liquid. Thus, as used herein, a “moisture sensor” that measures the moisture content within a device includes measuring the water vapor content, the humidity level, the water level and any condensed or diffused liquid level within the device. Thus, when the “moisture content” is measured and/or lowered, in some embodiments, the moisture content is a humidity level, a water vapor level, a water level, or combinations thereof.

In some embodiments, the substance detection device will only be ready for threat analysis when the water content is within a desirable window. When the gas moisture content is outside the desirable window, a mobility calibration is triggered (manually or automatically) to adjust the mobility values or drift time values of the threat library relative to the change in the calibrant's new measured drift time. Since not all of the ion species' mobilities shift by the same amount, specific calibration factors for each of the threats are pre-determined at various moisture settings so that when the system senses a certain change in moisture level during operation, the threat library with specific mobility or drift time values at such given moisture levels is re-called for computing alarm detection.

Thus, in one embodiment of the present disclosure, a substance detection device is disclosed. The device comprises an inlet for receiving a sample to be tested for the presence of at least one substance of interest; an ionization chamber; a drift chamber; and, at least one moisture sensor. In some embodiments, the substance detection device further comprises at least one of a dryer, an ion collector, a doping chamber, a plumbing system, a gas line in flow communication with a dryer, a gas line in flow communication with a doping chamber, and an exhaust outlet.

In some embodiments, the substance detection device further comprises at least one calibrated library, at least two calibrated libraries, or at least three calibrated libraries. In some embodiments, the substance detection device comprises from about 1 to about 5 calibrated libraries. The calibrated libraries are pre-determined detection libraries that include mobility values and drift time values of substances of interest at various humidity levels.

The substance detection device comprises at least one moisture sensor. In some embodiments, the substance detection device comprises more than one moisture sensor, more than two moisture sensors, more than three moisture sensors, or more than four moisture sensors. The number of moisture sensors used varies and is determined by the user of the device.

In some embodiments, the moisture sensor or sensors are located within at least one of the inlet, the drift chamber, and the ionization chamber. The location of the moisture sensor(s) varies and is determined by the user. In some embodiments, only one moisture sensor is used, while in other embodiments, multiple moisture sensors are used. When multiple moisture sensors are used, they are located within one part of the substance detection device (e.g., within the ionization chamber) or within more than one part of the substance detection device (e.g., within the ionization chamber, within the inlet and within the drift chamber).

In some embodiments, the moisture sensor or sensors are located within at least one of the plumbing of the substance detection device, the gas line after exit from the dryer, the gas line after exit from the doping chamber and the exhaust outlet.

In accordance with the present disclosure, the moisture sensors monitor at least one of the water vapor and humidity content (i.e., the moisture content) within the substance detection device. In some embodiments, the moisture sensors record and then report the moisture content on an instrument status window of the substance detection device.

In some embodiments of the present disclosure, the substance detection device includes at least one of an ion mobility spectrometer (IMS), an ion trap mobility spectrometer (ITMS), a drift spectrometer (DS), a non-linear drift spectrometer, a field ion spectrometer (FIS), a radio frequency ion mobility increment spectrometer (IMIS), a field asymmetric ion mobility spectrometer (FAIMS), an ultra-high-field FAIMS, a differential ion mobility spectrometer (DIMS) and a differential mobility spectrometer (DMS), a traveling wave ion mobility spectrometer, a semiconductor gas sensor, a raman spectrometer, a laser diode detector, a mass spectrometer (MS), an electron capture detector, a photoionization detector, a chemiluminescence-based detector, an electrochemical sensor, an infrared spectrometer, a lab-on-a-chip detector and combinations thereof.

The substance detection devices in accordance with the present disclosure are used to detect at least one of an explosive, an energetic material, a taggant, a narcotic, a toxin, a chemical warfare agent, a biological warfare agent, a pollutant, a pesticide, a toxic industrial chemical, a toxic industrial material, a homemade explosive, a pharmaceutical trace contaminant and combinations thereof. In some embodiments, the substance of interest includes at least one of nitrates, chlorates, perchlorates, nitrites, chlorites, permanganates, chromates, dichromates, bromates, iodates, and combinations thereof.

In some embodiments, the substance of interest includes at least one of ammonium nitrate (AN), ammonium nitrate fuel oil (ANFO), urea nitrate (UN), trinitrotoluene (TNT), ethylene glycol dinitrate (EGDN), nitroglycerin (NG), pentaerythritol tetranitrate (PETN), high melting explosive (HMX), triacetone triperoxide (TATP), hexamethylene triperoxide diamine (HMTD), erythritol tetranitrate (ETN), nitromethane, hydrogen peroxide and Research Department Explosive (RDX).

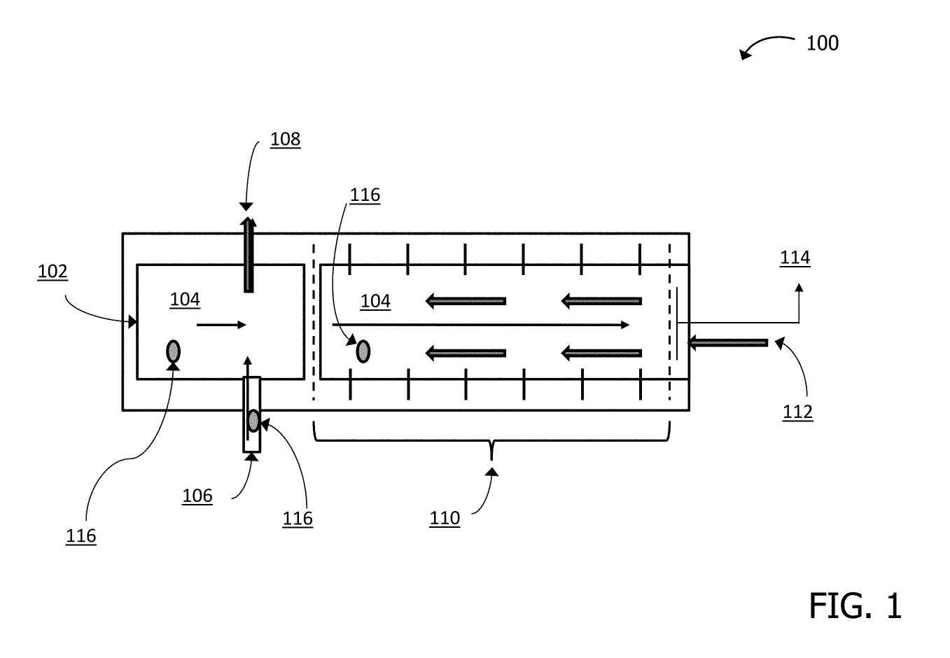

FIG. 1 is an exemplary embodiment of a substance detection device in accordance with the present disclosure. In the exemplary embodiment, substance detection device 100 comprises an ionization chamber 102 and a drift chamber 110. The device 100 includes a sample inlet 106 from which the substance of interest enters into the device 100. Once the substance of interest enters the ionization chamber 102, the substance is ionized to form ions of the substance of interest 104. The ions of the substance of interest 104 travel from the ionization chamber 102 into the drift chamber 110. The device 100 further includes an exhaust outlet 108. A drift gas 112 enters into the drift chamber 110 and flows either toward the ionization chamber 102 or away from the ionization chamber 102. The device 100 further includes an amplifier signal 114. Within the exemplary embodiment, the device 100 includes moisture sensors 116. The sensors 116 are located within the sample inlet 106, within the ionization chamber 102 and within the drift chamber 110. The moisture sensors 116 measure the moisture content within each of the sample inlet 106, the ionization chamber 102 and the drift chamber 110.

In another embodiment of the present disclosure, a method for calibrating a substance detection device is disclosed. The method comprises measuring a moisture content within a substance detection device; reporting the moisture content; and, performing a calibration, wherein the calibration adjusts at least one of a mobility value, a drift time value and a compensation voltage of at least one substance of interest.

In some embodiments, the moisture content is measured with one moisture sensor, more than one moisture sensor, more than two moisture sensors, or more than three moisture sensors. Each moisture sensor measures the moisture in the part of the substance detection device in which the sensor is located.

In accordance with the present disclosure, the moisture content (which includes humidity level) of the substance detection device is measured within the device where the moisture sensors are located. As noted elsewhere throughout this disclosure, the moisture sensors are located in at least one area of the substance detection device, at least two areas, or more. After a moisture sensor measures the moisture content, the sensor reports the moisture content on an instrument status window of the substance detection device. If the moisture content is higher than an acceptable level, then a mobility calibration is performed within the device. In some embodiments, the mobility calibration includes adjusting at least one of a mobility value, a drift time value and a compensation voltage of at least one substance of interest.

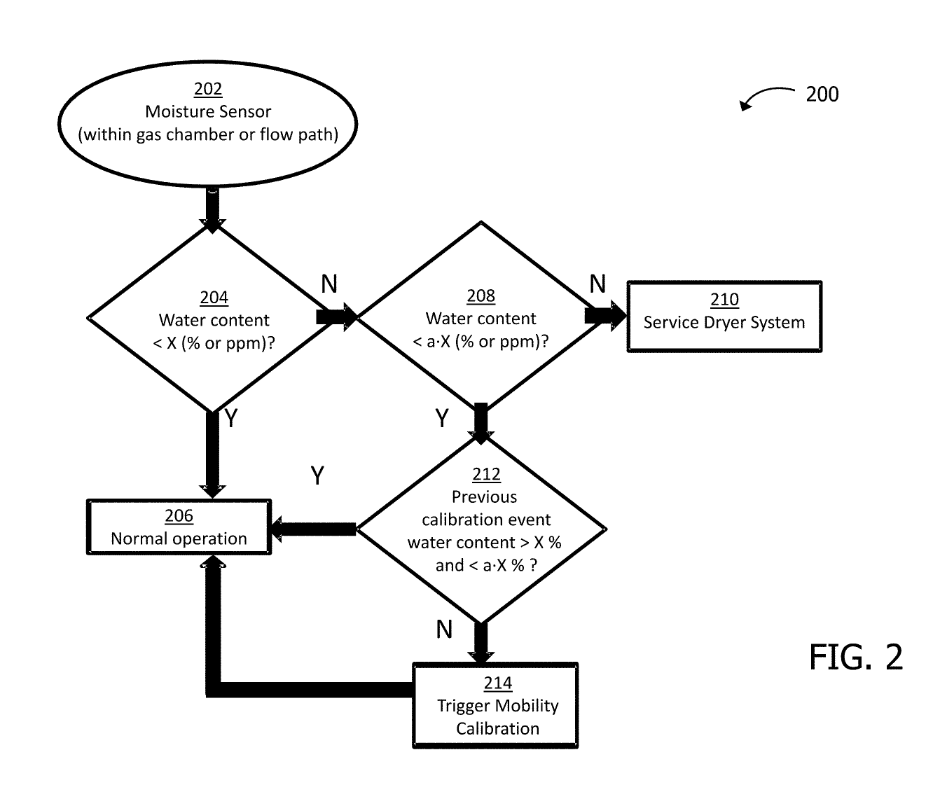

FIG. 2 is an exemplary embodiment of a mobility calibration method in accordance with the present disclosure. During analysis or idle condition, when the moisture content measured changes from smaller than X ppm to greater than X ppm, then a re-calibration of the library peaks position is performed with a mobility calibration sample, as shown in FIG. 2. This helps reset all the library mobility value and drift time value peak positions back appropriately with respect to the new calibrant peak(s). This action is acceptable, for example, when all the substances of interest in the library contain peaks that shift by a similar amount in comparison to the calibration peak.

The exemplary method 200 in FIG. 2 includes a moisture sensor 202 within a substance detection device measuring the moisture content within the device. Step 204 determines whether the moisture content is above an acceptable level (X). If the moisture content is about at or below the acceptable level (X), then the device continues with normal operation 206 and no mobility calibration is required.

If, however, after measuring the moisture content and the content is determined 204 to be above an acceptable level (X), then a second determination 208 occurs to verify if the moisture content is within an acceptable operating range (a-X) for which the substance detection device operates. If the determination 208 is made that the moisture content is within an acceptable operating range (a-X), then a third determination 212 step is made to compare a previously measured moisture content during operation of the device with the current moisture content. If the current moisture content is less than or equal to the previously measured moisture content, then normal operation 206 of the device continues and no mobility calibration is required.

If, however, the current moisture content is greater than the previously measured moisture content, a mobility calibration is triggered 214 within the device and then the device returns to operating at normal operation 206. The mobility calibration comprises flushing a sample through the device, measuring the movement of mobility value and/or drift time value peaks at the current moisture content, and then adjusting the mobility value and/or drift time value peaks for all substance of interest analytes at a previous moisture content by the amount of movement of the current moisture content.

In some embodiments of the present disclosure, the acceptable level (X) of moisture content in the substance detection device is about 5 ppm or less. Thus, in FIG. 2, if the moisture content is measured at about 5 ppm or less at step 204, then normal operation 206 of the device will continue. If, however, the moisture content is determined to be, for example, greater than about 5 ppm, then the second determination 208 is made.

In some embodiments, the acceptable operating range (a-X) of the moisture content is from about 5 ppm to about 5,000 ppm, from about 50 ppm to about 1,000 ppm, or from about 100 ppm to about 500 ppm. Thus, in FIG. 2, if the moisture content is determined at step 208 to be within 5 ppm to 5,000 ppm, then a comparison at step 212 is made. At step 212, the comparison is made to a previous moisture content of the device to the current moisture content. If the current moisture content, for example, is 100 ppm, and the previous moisture content was 200 ppm, then normal operation 206 of the device continues. If, however, the current moisture content is 100 ppm and the previous moisture content was 50 ppm, then the mobility calibration is triggered at step 214. Thus, if the current moisture content is greater than the previous moisture content, the mobility calibration step is triggered. Once the mobility calibration 214 has occurred, then the device returns to normal operation 206.

During the mobility calibration, a re-calibration of the library peaks position is performed with a mobility calibration sample. This helps reset all the library mobility value and drift time value peak positions back appropriately with respect to the new calibrant peak(s). This action is acceptable, for example, when all the substances of interest in the library contain peaks that shift by a similar amount in comparison to the calibration peak. For example, if the peaks measured at a moisture content of 10 ppm move by (Y) amount, then the peaks for all the substance of interest analytes will be moved by (Y) amount to be able to identify a particular substance of interest at a certain moisture content. Thus, in some embodiments of the present disclosure, the method further comprises recording at least one mobility spectrum of the at least one substance of interest, wherein the at least one mobility spectrum includes at least one peak. In some embodiments, the calibration comprises adjusting a drift time value of the at least one peak.

In some embodiments, the mobility calibration is performed automatically within the substance detection device. In other embodiments, the mobility calibration is performed manually by a user.

In another embodiment of the present disclosure, a method for detecting a substance of interest is disclosed. The method comprises collecting a sample of a substance of interest; inserting the sample of the substance of interest into a substance detection device, wherein the device comprises an inlet for receiving a sample to be tested for the presence of at least one substance of interest; an ionization chamber; a drift chamber; and, at least one moisture sensor; measuring a moisture content within the device; reporting the moisture content; and, comparing at least one of a mobility value, a drift time value and a compensation voltage of the substance of interest to a pre-determined mobility value, drift time value or compensation voltage; and, identifying the substance of interest.

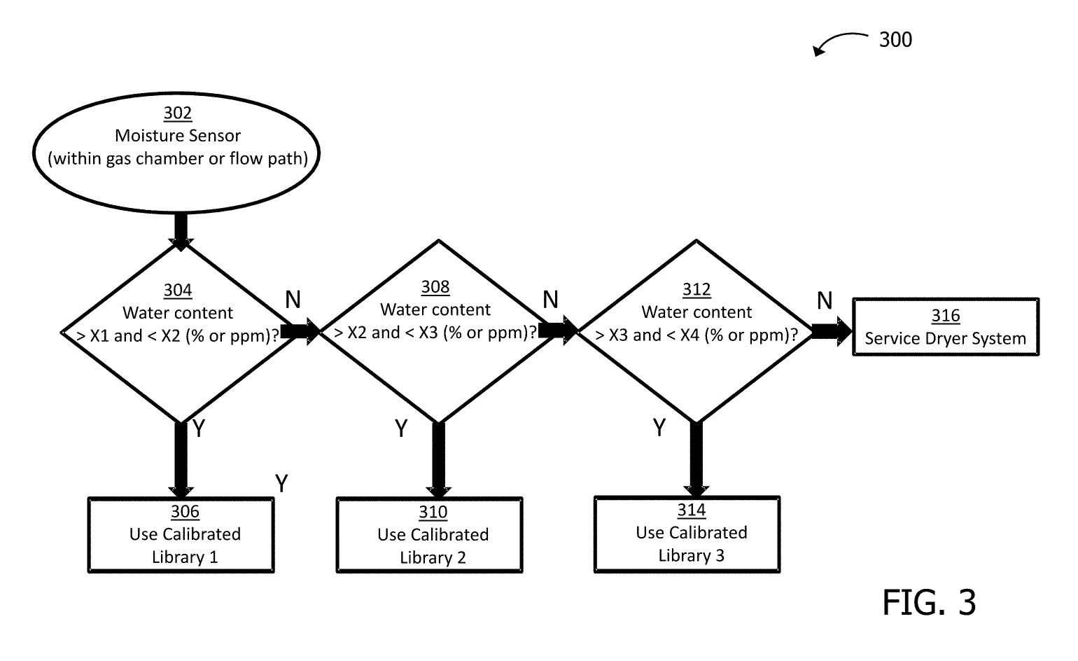

In accordance with this method, a moisture content is measured and then compared to pre-determined detection libraries at various moisture levels for each sample analysis that matches the current analysis moisture content. FIG. 3 is an exemplary embodiment of the method in accordance with the present disclosure wherein the substance detection device includes three pre-determined detection libraries (306, 310, 314). In this method 300, a moisture sensor measures the moisture content 302 within the substance detection device. At step 304, a determination is made to determine if the moisture content is within a pre-determined moisture content range that corresponds to a range within pre-determined detection library 306. If the moisture content is within that range, then the substance of interest is identified by its peak at that particular moisture content within the first pre-determined detection library.

If, however, the moisture content is not within the range at step 304, then a determination is made at step 308 to determine if the moisture content is within a second pre-determined moisture content range that corresponds to a range within the second pre-determined detection library 310. If the moisture content is within that range, then the substance of interest is identified by its peak at that particular moisture content within the second pre-determined detection library.

If, however, the moisture content is not within the range at step 308, then a determination is made at step 312 to determine if the moisture content is within a third pre-determined moisture content range that corresponds to a range within the third pre-determined detection library 314. If the moisture content is within that range, then the substance of interest is identified by its peak at that particular moisture content within the third pre-determined detection library.

FIG. 3 is an exemplary embodiment of the present disclosure, and the present disclosure is not limited to only three pre-determined detection libraries. In some embodiments, the pre-determined mobility value or drift time value is located in at least one pre-determined detection library, at least two pre-determined detection libraries, at least three pre-determined detection libraries, or more. In some embodiments, the pre-determined mobility value or drift time value is located in from about 2 to about 5 pre-determined detection libraries.

In an exemplary embodiment of the present disclosure, the method includes three pre-determined detection libraries. The first library includes mobility value and drift time values of substances of interest when the substance detection device has a moisture content within from about 5 ppm to about 50 ppm. The second library includes mobility value and drift time values of substances of interest when the substance detection device has a moisture content within from about 50 ppm to about 500 ppm. The third library includes mobility value and drift time values of substances of interest when the substance detection device has a moisture content within from about 500 ppm to about 5,000 ppm. Thus, in the exemplary embodiment, when the moisture sensor measures a moisture content within the substance detection device to be 100 ppm, the substance of interest being analyzed is identified by using the second library which includes the peaks of the mobility value and drift time value of the substance of interest at 100 ppm.

In accordance with the present disclosure, the number of libraries and the moisture content ranges within each library are not limited and are determined by a user. In some embodiments, the ranges are smaller or larger than in the exemplary embodiment. In some embodiments, the number of detection libraries used is smaller or larger than the exemplary embodiment. As noted elsewhere throughout this disclosure, the moisture sensor or sensors are located within the substance detection device at various positions and are not limited to one location.

In some embodiments, the method of identifying the substance of interest is performed automatically within the substance detection device. In other embodiments, the method of identifying the substance of interest is performed manually by a user.

In yet another embodiment of the present disclosure, a method for servicing a substance detection device is disclosed. The method comprises measuring a moisture content within a substance detection device, wherein the device includes at least one moisture sensor; and, servicing the substance detection device.

Exemplary embodiments of methods for servicing the dryer are shown in FIGS. 2 and 3. In FIG. 2, the method includes a moisture sensor 202 within a substance detection device measuring the moisture content within the device. Step 204 determines whether the moisture content is above or below an acceptable level (X). If the moisture content is about at or below the acceptable level (X), then the device continues with normal operation 206 and no servicing of the device is required.

If, however, after measuring the moisture content and the content is determined 204 to be above an acceptable level (X), then a second determination 208 occurs to verify if the moisture content is within an acceptable operating range (a-X) for which the substance detection device operates. If the determination 208 is made that the moisture content is within an acceptable operating range (a-X), then a third determination 212 step is made to compare a previously measured moisture content during operation of the device with the current moisture content.

If, however, the determination at step 208 is that the moisture content is not within an acceptable operating range (a-X), then the substance detection device is serviced 210. In some embodiments, the servicing of the substance detection device includes servicing a dryer within the device. In some embodiments, the servicing includes at least one of changing a dryer's adsorbent material and regenerating the dryer. After the substance detection device has been serviced, and the moisture content has been lowered to an acceptable operating level, then normal operation 206 of the substance detection device will occur.

FIG. 3 depicts another exemplary embodiment of a method of servicing the substance detection device in accordance with the present disclosure. In FIG. 3, if the moisture content of the substance detection system is determined 304, 308, 312 to be greater than any of the ranges of the pre-determined detection libraries 306, 310, 314, then the substance detection system is serviced by step 316.

In some embodiments of the present disclosure, the moisture content of an acceptable operating range of the substance detection system is less than about 5,000 ppm. Thus, if the moisture content is at or above about 5,000 ppm, then the substance detection system needs to be serviced. In some embodiments, the moisture content (measured as parts per million of water molecules in air) of the acceptable operating range of the substance detection system is less than about 10,000 ppm, less than about 9,000 ppm, less than about 8,000 ppm, less than about 7,000 ppm, less than about 6,000 ppm, less than about 5,000 ppm, less than about 4,000 ppm, less than about 3,000 ppm, less than about 2,000 ppm, or less than about 1,000 ppm.

In some embodiments, the servicing of the substance detection device is performed automatically. In other embodiments, the servicing of the substance detection device is performed manually by a user. In some embodiments, a rate of increase of moisture (e.g., humidity) is used to distinguish between a need for servicing the device and a need for fixing a leak in the device. That is, if the rate of moisture increase is above a certain amount, in some embodiments, a user is able to quickly understand that this rate means that there is a leak present in the device and that servicing the device will not necessarily lower the moisture content within the device.

In another embodiment of the present disclosure, a method for detecting a leak in a substance detection device is disclosed. The method comprises measuring a moisture content within a substance detection device, wherein the device includes at least one moisture sensor; and, identifying a leak within the substance detection device. In some embodiments, the method further comprises servicing the substance detection device such as, for example, by lowering the moisture content within the device.

The leak is identified by measuring the moisture content in the substance detection device and, optionally, further inspecting the device for the leak. In some embodiments, the leak is identified when the moisture content of the device is greater than about 1,000 ppm, about 2,000 ppm, about 3,000 ppm, about 4,000 ppm, about 5,000 ppm, about 6,000 ppm, about 7,000 ppm, about 8,000 ppm, about 9,000 ppm or about 10,000 ppm.

In some embodiments, the leak occurs in the substance detection device within at least one of an inlet, an ionization chamber, a drift chamber, a dryer, a doping chamber, an ion collector, within plumbing of the device, within an IMS detector, within a gas line after exit from a dryer, within a gas line after exit from a doping chamber, and within an exhaust outlet.

For example, in some embodiments, the moisture content is measured and is at a level that is above the acceptable operating range of the substance detection device, such as, for example, above about 5,000 ppm. If, after servicing the substance detection device to lower the moisture content, the moisture content remains at or above 5,000 ppm, then a leak may be present in the device. A user then inspects the device to identify where the leak may be occurring. After identifying the leak, the substance detection device is then repaired by fixing the leak and lowering the moisture content within the device.

### EXAMPLE

The following example describes or illustrates various embodiments of the present disclosure. Other embodiments within the scope of the appended claims will be apparent to a skilled artisan considering the specification or practice of the disclosure as described herein. It is intended that the specification, together with the Example, be considered exemplary only, with the scope and spirit of the disclosure being indicated by the claims, which follow the Example.

### Example 1

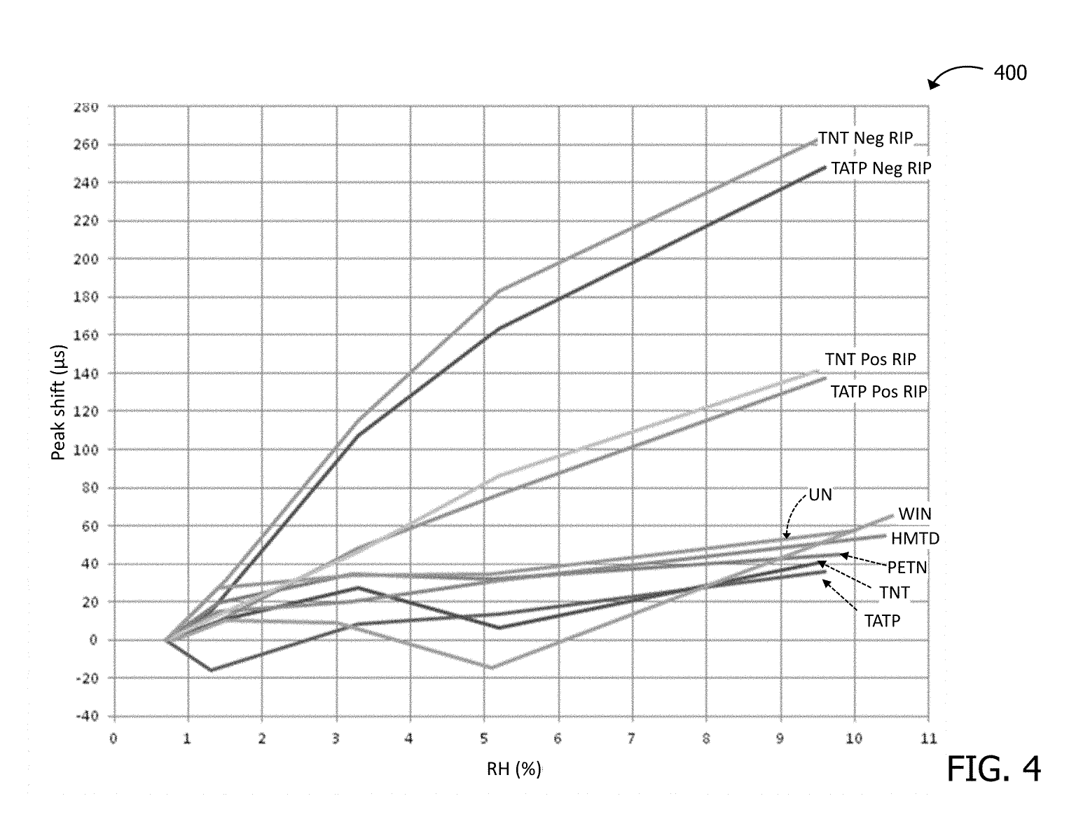

Example 1 is an exemplary embodiment of the peak shift of various substances of interest depending upon the humidity level within a substance detection device. In particular, FIG. 4 depicts how different substances of interest shift by different amounts (measured by microseconds) at different humidity levels 400. In particular, TNT and TATP shifted significantly when the relative humidity percentage increased from 3-10% within the substance detection device.

In this example, a user is able to identify each substance of interest (such as TNT and TATP) even when the humidity level—and thus the peak positions—changes because live data reading from the humidity sensors allowed for software algorithms to determine the appropriate pre-determined library so that the substances' peak positions were accurately assigned and compared against the current sample analyses.

Without the use of the humidity sensor and the pre-determined detection libraries, peaks such as the TNT and TATP peaks would appear as false negatives as seen in FIG. 4 due to the humidity change and thus the substances of interest would go undetected. The present disclosure corrects this problem and allows for the proper calibration of the substance detection device and identification of each substance of interest by measuring the moisture content and comparing the reported peaks to pre-determined substance peaks in a library.

Exemplary embodiments of substance detection systems for determining the presence of substances of interest, and methods of operating such systems are not limited to the specific embodiments described herein, but rather, components of systems and/or steps of the methods may be utilized independently and separately from other components and/or steps described herein. For example, the methods may also be used in combination with other systems requiring determining the presence of substances of interest, and are not limited to practice with only the substance detection systems and methods as described herein. Rather, the exemplary embodiment is implemented and utilized in connection with many other substance detection applications that are currently configured to determine the presence of substances of interest.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

Some embodiments involve the use of one or more electronic or computing devices. Such devices typically include a processor or controller, such as a general purpose central processing unit (CPU), a graphics processing unit (GPU), a microcontroller, a reduced instruction set computer (RISC) processor, an application specific integrated circuit (ASIC), a programmable logic circuit (PLC), and/or any other circuit or processor capable of executing the functions described herein. The methods described herein may be encoded as executable instructions embodied in a computer readable medium, including, without limitation, a storage device and/or a memory device. Such instructions, when executed by a processor, cause the processor to perform at least a portion of the methods described herein. The above examples are exemplary only, and thus are not intended to limit in any way the definition and/or meaning of the term processor.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A substance detection device comprising:
an inlet for receiving a sample to be tested for the presence of at least one substance of interest;
an ionization chamber;
a drift chamber; and,
at least one moisture sensor.

2. The substance detection device of claim 1, further comprising at least one of a dryer, an ion collector, a doping chamber, a plumbing system, a gas line in flow communication with a dryer, a gas line in flow communication with a doping chamber, and an exhaust outlet.

3. The substance detection system of claim 2, wherein the at least one moisture sensor is located in at least one of the inlet, the drift chamber, the ionization chamber, the dryer, the ion collector, the doping chamber, the plumbing system, the gas line in flow communication with the dryer, the gas line in flow communication with the doping chamber, and the exhaust outlet.

4. The substance detection device of claim 1, further comprising at least one pre-determined detection library.

5. The substance detection system of claim 1, wherein the device includes at least one of an ion mobility spectrometer (IMS), an ion trap mobility spectrometer (ITMS), a drift spectrometer (DS), a non-linear drift spectrometer, a field ion spectrometer (FIS), a radio frequency ion mobility increment spectrometer (IMIS), a field asymmetric ion mobility spectrometer (FAIMS), an ultra-high-field FAIMS, a differential ion mobility spectrometer (DIMS) and a differential mobility spectrometer (DMS), a traveling wave ion mobility spectrometer, a semiconductor gas sensor, a raman spectrometer, a laser diode detector, a mass spectrometer (MS), an electron capture detector, a photoionization detector, a chemiluminescence-based detector, an electrochemical sensor, an infrared spectrometer, a lab-on-a-chip detector and combinations thereof.

6. A method for calibrating a substance detection device, the method comprising:
measuring a moisture content within a substance detection device;
reporting the moisture content; and,
performing a calibration, wherein the calibration adjusts at least one of a mobility value, a drift time value and a compensation voltage of at least one substance of interest.

7. The method of claim 6, wherein performing the calibration occurs when the moisture content is greater than about 5 ppm.

8. The method of claim 6, wherein performing the calibration occurs when the moisture content is from about 5 ppm to about 5,000 ppm.

9. The method of claim 6, wherein the moisture content is measured with at least one moisture sensor located within the substance detection device.

10. The method of claim 6, wherein the calibration is performed by inserting a sample into the substance detection device, measuring any movement of the at least one mobility value and the drift time value of the sample, and adjusting the at least one mobility value and drift time value of the substance of interest by the amount of movement measured.

11. The method of claim 6, wherein the substance detection device includes at least one of an ion mobility spectrometer (IMS), an ion trap mobility spectrometer (ITMS), a drift spectrometer (DS), a non-linear drift spectrometer, a field ion spectrometer (FIS), a radio frequency ion mobility increment spectrometer (IMIS), a field asymmetric ion mobility spectrometer (FAIMS), an ultra-high-field FAIMS, a differential ion mobility spectrometer (DIMS) and a differential mobility spectrometer (DMS), a traveling wave ion mobility spectrometer, a semiconductor gas sensor, a raman spectrometer, a laser diode detector, a mass spectrometer (MS), an electron capture detector, a photoionization detector, a chemiluminescence-based detector, an electrochemical sensor, an infrared spectrometer, a lab-on-a-chip detector and combinations thereof.

12. A method for detecting a substance of interest, the method comprising:
collecting a sample of a substance of interest;
inserting the sample of the substance of interest into a substance detection device, wherein the device comprises an inlet for receiving a sample to be tested for the presence of at least one substance of interest; an ionization chamber; a drift chamber; and, at least one moisture sensor;
measuring a moisture content within the device;
reporting the moisture content;
comparing at least one of a mobility value, a drift time value and a compensation voltage of the substance of interest to a pre-determined mobility value, drift time value or compensation voltage; and,
identifying the substance of interest.

13. The method of claim 12, wherein the pre-determined mobility value, drift time value or compensation voltage is located in at least one pre-determined detection library.

14. The method of claim 13, wherein the pre-determined mobility value, drift time value or compensation voltage is located in one of three different pre-determined detection libraries.

15. The method of claim 14, wherein the first detection library is used for comparison when the moisture content of the substance detection device is from about 5 ppm to about 50 ppm.

16. The method of claim 14, wherein the second detection library is used for comparison when the moisture content of the substance detection device is from about 50 ppm to about 500 ppm.

17. The method of claim 14, wherein the third detection library is used for comparison when the moisture content of the substance detection device is from about 500 ppm to about 5,000 ppm.

18. The method of claim 12, wherein the substance detection device includes at least one of an ion mobility spectrometer (IMS), an ion trap mobility spectrometer (ITMS), a drift spectrometer (DS), a non-linear drift spectrometer, a field ion spectrometer (FIS), a radio frequency ion mobility increment spectrometer (IMIS), a field asymmetric ion mobility spectrometer (FAIMS), an ultra-high-field FAIMS, a differential ion mobility spectrometer (DIMS) and a differential mobility spectrometer (DMS), a traveling wave ion mobility spectrometer, a semiconductor gas sensor, a raman spectrometer, a laser diode detector, a mass spectrometer (MS), an electron capture detector, a photoionization detector, a chemiluminescence-based detector, an electrochemical sensor, an infrared spectrometer, a lab-on-a-chip detector and combinations thereof.

19. A method for servicing a substance detection device, the method comprising:
measuring a moisture content within a substance detection device, wherein the device includes at least one moisture sensor; and,
servicing the substance detection device.

20. The method of claim 19, wherein servicing the substance detection device includes lowering the moisture content within the device.

21. The method of claim 19, wherein the moisture content within the device is greater than about 5,000 ppm.

22. The method of claim 19, wherein the substance detection device includes at least one of an ion mobility spectrometer (IMS), an ion trap mobility spectrometer (ITMS), a drift spectrometer (DS), a non-linear drift spectrometer, a field ion spectrometer (FIS), a radio frequency ion mobility increment spectrometer (IMIS), a field asymmetric ion mobility spectrometer (FAIMS), an ultra-high-field FAIMS, a differential ion mobility spectrometer (DIMS) and a differential mobility spectrometer (DMS), a traveling wave ion mobility spectrometer, a semiconductor gas sensor, a raman spectrometer, a laser diode detector, a mass spectrometer (MS), an electron capture detector, a photoionization detector, a chemiluminescence-based detector, an electrochemical sensor, an infrared spectrometer, a lab-on-a-chip detector and combinations thereof.

22. A method for detecting a leak in a substance detection device, the method comprising:
measuring a moisture content within a substance detection device, wherein the device includes at least one moisture sensor; and,
identifying a leak within the substance detection device.

23. The method of claim 22, further comprising servicing the substance detection device.

24. The method of claim 22, wherein the moisture content is greater than about 5,000 ppm.

25. The method of claim 22, wherein the substance detection device includes at least one of an ion mobility spectrometer (IMS), an ion trap mobility spectrometer (ITMS), a drift spectrometer (DS), a non-linear drift spectrometer, a field ion spectrometer (FIS), a radio frequency ion mobility increment spectrometer (IMIS), a field asymmetric ion mobility spectrometer (FAIMS), an ultra-high-field FAIMS, a differential ion mobility spectrometer (DIMS) and a differential mobility spectrometer (DMS), a traveling wave ion mobility spectrometer, a semiconductor gas sensor, a raman spectrometer, a laser diode detector, a mass spectrometer (MS), an electron capture detector, a photoionization detector, a chemiluminescence-based detector, an electrochemical sensor, an infrared spectrometer, a lab-on-a-chip detector and combinations thereof.
